(19) United States
(12) Patent Application Publication
(10) Pub. No.: US 2013/0103393 A1
(43) Pub. Date: Apr. 25, 2013

(54) Multi-point sound mixing and distant view presentation method, apparatus and system

(71) Applicants: Mingliang Wu, Shenzhen (CN); Bo Sun, Shenzhen (CN)

(72) Inventors: Mingliang Wu, Shenzhen (CN); Bo Sun, Shenzhen (CN)

(73) Assignee: ZTE CORPORATION, Shenzhen, GD (CN)

(21) Appl. No.: 13/806,275

(22) PCT Filed: Dec. 27, 2010
(86) PCT No.: PCT/CN2010/080331

§ 371 Date: Dec. 21, 2012

(30) Foreign Application Priority Data
Jun. 29, 2010 (CN) 201010218209.7

(51) Int. Cl. G10L 19/008

(52) U.S. Cl. CPC G10L 19/008
USPC 704/201

(57) ABSTRACT

The disclosure provides a multi-point sound mixing and distant view presentation method, apparatus and system, wherein the multi-point sound mixing and distant view presentation method includes: receiving audio code streams from a plurality of meeting places, wherein each meeting place comprises one or more meeting sections, and each meeting section corresponds to one audio code stream; mixing the audio code streams of the meeting sections which have a corresponding relationship among the plurality of meeting places; and outputting mixed audio code streams to the meeting sections which have the corresponding relationship among the plurality of meeting places. Sounds in different sections of the distant view presentation conference system can be distinguished by technical solutions provided by the disclosure.

### TECHNICAL FIELD

The disclosure relates to the field of communications, and in particular to a multi-point sound mixing and distant view presentation method, apparatus and system.

### BACKGROUND

Distant view presentation is welcomed by high-end users because of its real presence. Position distinguishing via listening to the sound, real size and eye contact are key technical indexes in the distant view presentation.

In a traditional conference system, each meeting place only has one path of audio or two paths of audios. The sound which is able to be listened in each meeting place is the sound after mixing and superposing three meeting places with a loudest sound in the whole meeting. There is only one input source and one output of the sound in each meeting place, therefore people cannot distinguish which position of the meeting place the sound is given from.

In a distant view presentation conference system, each meeting place has a single screen or a plurality of screens, wherein each screen displays an image of one participant, and each participant corresponds to one audio input correspondingly. In order to achieve the position distinguishing via listening to the sound, under the condition of a plurality of screens, for example, in a three-screen meeting place, if a participant in a left seat is speaking, participants in other meeting places should be able to distinguish that the sound is let out from the left side; if a participant in a middle seat is speaking, the participants of other meeting places should be able to distinguish that the sound is from the middle place; and if a participant in a right seat is speaking, the participants in other meeting places should be able to distinguish that the sound is from the right side. The position from which the sound is given should be the same as the position on which the screen, which shows the image of the speaker, is located, namely, the sound follows the image.

In this case, the input and output of the audios with different positions need to be mixed distinguishingly. A traditional single-audio sound mixing method obviously cannot satisfy such a situation. In addition, in a multi-point conference in which a single-screen meeting place and a multi-screen meeting place intercommunicate with each other, the problem that how to mix and output the sound of the single-screen meeting place and the multi-screen meeting place without influencing the effect of distinguishing positions via listening to the sounds of the two meeting places also needs to be solved.

The inventor finds that the distant view presenting conference system is hard to distinguish sounds in different sections in above related techniques.

### SUMMARY

The disclosure provides a multi-point sound mixing and distant view presentation method, apparatus and system, which at least solves the problem that the above distant view presentation conference system is hard to distinguish the sounds in different sections. According to one aspect of the disclosure, a multi-point sound mixing and distant view presentation method is provided, comprising: receiving audio code streams from a plurality of meeting places, wherein each meeting place comprises one or more meeting sections, and each meeting section corresponds to one of the audio code streams; mixing the audio code streams of the meeting sections which have a corresponding relationship among the plurality of meeting places; and outputting mixed audio code streams to the meeting sections which have the corresponding relationship among the plurality of meeting places.

Preferably, each of the meeting sections respectively corresponds to different positions, and the step of mixing the audio code streams of the meeting sections which have the corresponding relationship among the plurality of meeting places comprises: mixing the audio code streams of the meeting sections with a same position in each meeting place; the step of outputting the mixed audio code streams to the meeting sections which have the corresponding relationship among the plurality of meeting places comprises: outputting the mixed audio code streams to the meeting sections with the same position.

Preferably, each of the audio code streams comprises position information of a meeting section, and the step of mixing the audio code streams of the meeting sections with the same position in each meeting place comprises: mixing the audio code streams of the meeting sections with the same position in each meeting place according to the position information.

Preferably, in a case that a first meeting place which comprises one meeting section and a second meeting place which comprises a plurality of meeting sections exist in the plurality of meeting places, the step of mixing the audio code streams of the meeting sections which have the corresponding relationship among the plurality of meeting places comprises: mixing an audio code stream of the meeting section of the first meeting place and an audio code stream of one of the meeting sections of the second meeting place.

Preferably, the step of outputting the mixed audio code streams to the meeting sections which have the corresponding relationship among the plurality of meeting places comprises: outputting the mixed audio code streams to the meeting section of the first meeting place and the meeting section, of which the audio code stream is mixed with the audio code stream of the meeting section of the first meeting place, in the second meeting place.

Preferably, the method further comprises: mixing the audio code streams of all meeting sections in the plurality of meeting places, and outputting the mixed audio code streams to the first meeting place.

Preferably, at least one of the plurality of meeting places comprises three meeting sections, wherein the three meeting sections comprise a left meeting section, a middle meeting section and a right meeting section.

According to another aspect of the disclosure, a multi-point sound mixing and distant view presentation apparatus is provided, comprising: a receiving module, configured to receive audio code streams from a plurality of meeting places, wherein each meeting place comprises one or more meeting sections, and each meeting section corresponds to one of the audio code streams; a sound mixing module, configured to mix the audio code streams of the meeting sections which have a corresponding relationship among the plurality of meeting places; an outputting module, configured to output mixed audio code streams to the meeting sections which have the corresponding relationship among the plurality of meeting places.

According to still another aspect of the disclosure, a multi-point sound mixing and distant view presentation system is provided, comprising: a plurality of meeting places, wherein each meeting place comprises one or more meeting sections, and each meeting section corresponds to one audio code stream; a multi-point sound mixing and distant view presentation apparatus, configured to mix audio code streams of the meeting sections which have a corresponding relationship among the plurality of meeting places, and output mixed audio code streams to the meeting sections which have the corresponding relationship among the plurality of meeting places.

Preferably, the meeting sections which have the corresponding relationship among the plurality of meeting places are the meeting sections with same position information in each meeting place.

In accordance with the disclosure, audio code streams are received from a plurality of meeting places, wherein each meeting place includes one or more meeting sections, and each meeting section corresponds to one audio code stream; the audio code streams of the meeting sections which have a corresponding relationship among the plurality of meeting places are mixed; and the mixed audio code streams are output to the meeting sections which have the corresponding relationship among the plurality of meeting places. In this way, the problem that the distant view presentation conference system is hard to distinguish the sounds in different sections is solved; and the effect of distinguishing the sounds in different sections in the distant view presentation conference system can be achieved.

### BRIEF DESCRIPTION OF THE DRAWINGS

Drawings, provided for further understanding of the disclosure and forming a part of the specification, are used to explain the disclosure together with embodiments of the disclosure rather than to limit the disclosure, wherein:

FIG. 1 shows a schematic diagram of a multi-point sound mixing and distant view presentation apparatus according to a first embodiment of the disclosure;

FIG. 2 shows a flowchart of a multi-point sound mixing and distant view presentation method according to the first embodiment of the disclosure;

FIG. 3 shows a flowchart of a multi-point sound mixing and distant view presentation method according to a second embodiment of the disclosure;

FIG. 4 shows a schematic diagram of a multi-point sound mixing and distant view presentation apparatus according to the second embodiment of the disclosure;

FIG. 5 shows a schematic diagram of a multi-point sound mixing conference system according to an embodiment of the disclosure.

### DETAILED DESCRIPTION OF THE EMBODIMENTS

The disclosure is described below in details with reference to the drawings and embodiments. It should be noted that, the embodiments of the application and the characteristics of the embodiments can be mutually combined under the condition of no conflict.

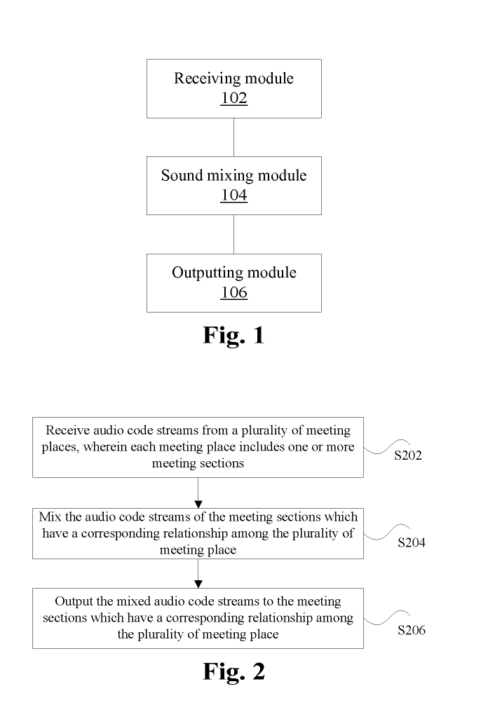

FIG. 1 shows a schematic diagram of a multi-point sound mixing and distant view presentation apparatus according to a first embodiment of the disclosure.

As shown in FIG. 1, the multi-point sound mixing and distant view presentation apparatus includes a receiving module 102, a sound mixing module 104 and an outputting module 106.

In the above, the receiving module 102 is configured to receive audio code streams from a plurality of meeting places, wherein each meeting place includes one or more meeting sections, and each meeting section corresponds to one of the audio code streams. The sound mixing module 104 is configured to mix the audio code streams of the meeting sections which have a corresponding relationship among the plurality of meeting places. The outputting module 106 is configured to output mixed audio code streams to the meeting sections which have the corresponding relationship among the plurality of meeting places.

FIG. 2 shows a flowchart of a multi-point sound mixing and distant view presentation method according to the first embodiment of the disclosure. The method can be implemented by using the above multi-point sound mixing and distant view presentation apparatus. As shown in FIG. 2, the method includes steps as follows.

Step S202, audio code streams are received from a plurality of meeting places, wherein each meeting place includes one or more meeting sections, and each meeting section corresponds to one of the audio code streams.

For example, in the plurality of meeting places, all the meeting places can be the meeting places including a plurality of meeting sections, and also, one or more meeting places can only include one meeting section.

The meeting place can include one or more screens, and each screen corresponds to one meeting section. A camera apparatus and an audio apparatus can be arranged in each screen or each meeting section.

Step S204, the audio code streams of the meeting sections which have a corresponding relationship among the plurality of meeting places are mixed. For example, the meeting sections which have the corresponding relationship among the plurality of meeting places can be the meeting sections with the same position (direction), and also can be any meeting sections which are set to have corresponding relationship between each other. For example, the sections can be divided into left sections and right sections, and the audio code streams of the left sections in each meeting place are mixed, and the audio code streams in the right sections in each meeting place are mixed.

Step S206, mixed audio code streams are output to the meeting sections which have the corresponding relationship among the plurality of meeting places. For example, after the audio code streams in the left sections in each meeting place are mixed, the mixed audio code stream is output to the left sections in each meeting place; and after the audio code streams in the right sections in each meeting place are mixed, the mixed audio code stream is output to the right sections in each meeting place.

In the above embodiment, the audio code streams of the meeting sections, which have the corresponding relationship among the plurality of meeting places, are mixed and output to the corresponding meeting sections, therefore, the sounds in different sections in the distant view presentation conference system can be distinguished, thus improving the user experience.

Preferably, each meeting section respectively corresponds to different positions. The step of mixing the audio code streams of the meeting sections which have the corresponding relationship among the plurality of meeting places includes: the audio code streams of the meeting sections with the same position in each meeting place are mixed. The step of outputting the mixed audio code streams to the meeting sections which have the corresponding relationship among the plurality of meeting places includes: outputting the mixed audio code steams to the meeting sections with the same position. The effect of distinguishing positions via listening to the sound can be achieved via the embodiment.

Preferably, each of the audio code streams includes position information of the meeting section. The step of mixing the audio code streams of the meeting sections with the same position in each meeting place includes: the audio code streams of the meeting sections with the same position in each meeting place are mixed according to the position information. The effect of distinguishing position via listening to the sound can be achieved simply via the embodiment.

Preferably, in a case that a first meeting place which includes one meeting section and a second meeting place which includes a plurality of meeting places exist in the plurality of meeting places, the step of mixing the audio code streams of the meeting sections which have the corresponding relationship among the plurality of meeting places includes: an audio code stream of the meeting section in the first meeting place is mixed with an audio code stream of one of the meeting sections in the second meeting place.

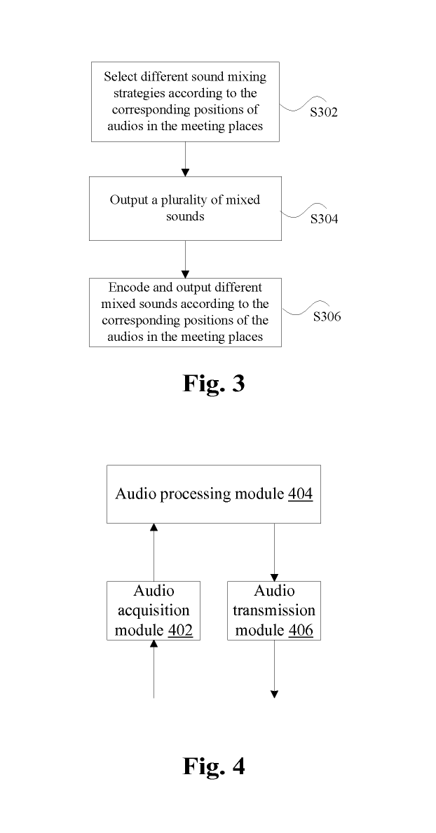

FIG. 3 shows a flowchart for processing an audio data stream in a multi-point sound mixing method according to an embodiment of the disclosure. By taking a multi-point conference in which a three-screen meeting place and a single-screen meeting place exist as an example, as shown in FIG. 3, the method includes steps as follows.

Step S302, during a meeting process, each meeting place includes a plurality of screens, and each screen corresponds to one audio input (one path of audio input), the sounds are mixed distinguishingly according to the positions of the left seat, the middle seat and the right seat that each audio code stream locates in the meeting place.

For example, the sounds are mixed distinguishingly according to the positions of the left seat, the middle seat and the right seat that each audio code stream locates in the meeting place. Namely, the sounds input by the left seats of all the meeting places are mixed and superposed; the sounds input by the middle seats of all the meeting places are mixed and superposed, and the sounds input by the right seats of all the meeting places are mixed and superposed, the single-screen meeting place is taken as a special middle seat to participate in sound mixing of all the middle seats; meanwhile, all the input sounds of the meeting place are additionally mixed and superposed, thus four groups of mixed sounds are obtained. For example, a multi-point conference is held in 3 three-screen meeting places A, B and C and one single-screen meeting place D, the three paths of sounds input by the left seats of the three-screen meeting places A, B and C can be mixed and superposed, the total four paths of sounds, namely, the sounds of three middle seats of the three-screen meeting places A, B and C and the sound of the single-screen meeting place D can be mixed and superposed; the three paths of sounds input by the right seats of the three-screen meeting places A, B and C can be mixed and superposed; and the total 10 paths of sounds input by A, B, C and D can be mixed and superposed.

Step S304, after implementing sound mixing for all the input code streams, a conference audio processing module outputs a plurality of mixed audio code streams, including the mixed audio code stream of the left seat, the mixed audio code stream of the middle seat, the mixed audio code stream of the right seat and the mixed audio code stream of all seats.

The conference audio processing module outputs four groups of mixed audio code streams after implementing sound mixing for all the input code streams, wherein the four groups of mixed audio code streams include the mixed audio code stream of all the left seats, the mixed audio code stream of all the middle seats, the mixed audio code stream of all the right seats and the mixed audio code streams of all the seats.

Step S306, different mixed audio code streams are encoded and output to different positions of the meeting places according to the situations of each meeting place. For example, the input audio code streams of the left seats are mixed and output to the left seats, the input audio code streams of the middle seats are mixed and output to the middle seats, and the input audio code streams of the right seats are mixed and output to the right seats, thus achieving the effect of distinguishing position via listening to the sound. When the single-screen meeting place and the multi-screen meeting place communicate mutually, the input audio code streams of all the seats are mixed and then output to the single-screen meeting place; the audio code stream input by the single-screen meeting place is mixed with the audio code streams of all the middle seats, and the obtained audio code stream is output to the middle seats of the multi-screen meeting place.

According to the situations of each meeting place, different mixed audio code streams can be encoded and output to different positions of the meeting places. For example, the mixed audio code stream of all the left seats are encoded and output to the left seats, the mixed audio code stream of all the middle seats are encoded and output to the middle seats, and the mixed audio code stream of all the right seats are encoded and output to the right seats, so as to achieve the effect of distinguishing positions by listening to the sounds. When the single-screen meeting place and the multi-screen meeting place communicate mutually, the mixed audio code stream of all the seats is encoded and output to the single-screen meeting place; the audio code stream input by the single-screen meeting place is mixed with the audio code streams of all the middle seats, and the obtained audio code stream is encoded and output to the middle seats of the multi-screen meeting place.

For example, the mixed audio code stream of all the left seats can be encoded and output to the left seats of A, B and C; the mixed audio code stream of all the middle seats can be encoded and output to the middle seats of A, B and C; the mixed audio code stream of all the right seats can be encoded and output to the right seats of A, B and C; and the mixed audio code stream of all the seats are encoded and output to the single-screen meeting place D.

The sound mixing method in above embodiments can support the sound-follow-image in the conference system. According to the situations of each meeting place in the conference, the single-seat meeting place and the multi-seat meeting place can both implement effective sound mixing, without influencing the effect of distinguishing positions by listening to the sounds.

FIG. 4 shows a schematic diagram of a multi-point sound mixing and distant view presentation apparatus according to a second embodiment of the disclosure.

An audio processing apparatus can include: an audio acquisition module 402, configured to acquire each audio code stream in meeting places; an audio processing module 404, configured to process the audio code streams, mix the audio code streams in the meetings, mix, encode and output the sound according to the input positions of audios in the meeting place; an audio transmission module 406, configured to output the mixed and encoded audios to the meeting places.

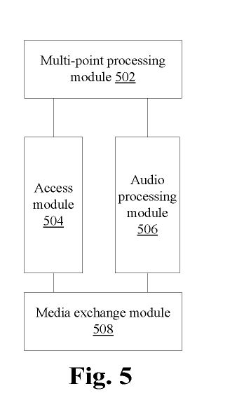

FIG. 5 shows a schematic diagram of a multi-point sound mixing conference system according to an embodiment of the disclosure.

As shown in FIG. 5, the multi-point sound mixing conference system can include a multi-point processing module 502, an access module 504, an audio processing module 506 and a media exchange module 508.

In the above, the multi-point processing module 502 is configured to control multi-point access, audio processing and media exchange. The access module 504 is configured to access a plurality of audio code streams of all the meeting places in the conference. The audio processing module 506 is configured to switch between encoding and decoding of all the audio code streams in the meeting places, and encode and output after mixing the sounds; the media exchange module 508 is configured to exchange and output the code streams output by the audio processing module to each meeting place.

A multi-point sound mixing and distant view presentation system is also provided according to an embodiment of the disclosure. The system includes: a plurality of meeting places, wherein each meeting place includes one or more meeting sections, and each meeting section corresponds to one audio code stream; a multi-point sound mixing and distant view presentation apparatus, configured to mix the audio code streams of the meeting sections which have a corresponding relationship among the plurality of meeting places, and output mixed audio code streams to the meeting sections which have the corresponding relationship among the plurality of meeting places.

In the above, the multi-point sound mixing and distant view presentation apparatus in the system embodiment can be any one of the multi-point sound mixing and distant view presentation apparatus in the above embodiments.

Preferably, the meeting sections which have the corresponding relationship among the plurality of meeting places can be the meeting sections with same position information in each meeting place.

It can be concluded from the above descriptions that the embodiments of the disclosure can solve one or more problems existing in multi-point sound mixing in the distant view presentation conference system, thus achieving the effect of distinguishing the sounds from different sections, and achieving the high-presence effect of distinguishing position by listening to the sound.

Obviously, those skilled in the art shall understand that the above-mentioned modules and steps of the disclosure can be realized by using general purpose calculating device, can be integrated in one calculating device or distributed on a network which consists of a plurality of calculating devices. Alternatively, the modules and the steps of the disclosure can be realized by using the executable program code of the calculating device. Consequently, they can be stored in the storing device and executed by the calculating device, or they are made into integrated circuit module respectively, or a plurality of modules or steps thereof are made into one integrated circuit module. In this way, the disclosure is not restricted to any particular hardware and software combination.

The descriptions above are only the preferable embodiment of the disclosure, which are not used to restrict the disclosure. For those skilled in the art, the disclosure may have various changes and variations. Any amendments, equivalent substitutions, improvements, etc. within the principle of the disclosure are all included in the scope of the protection of the disclosure.

1. A multi-point sound mixing and distant view presentation method, comprising:
receiving audio code streams from a plurality of meeting places, wherein each meeting place comprises one or more meeting sections, and each meeting section corresponds to one of the audio code streams;
mixing the audio code streams of the meeting sections which have a corresponding relationship among the plurality of meeting places; and
outputting mixed audio code streams to the meeting sections which have the corresponding relationship among the plurality of meeting places.

2. The method according to claim 1, wherein each of the meeting sections respectively corresponds to different positions, and the step of mixing the audio code streams of the meeting sections which have the corresponding relationship among the plurality of meeting places comprises:
mixing the audio code streams of the meeting sections with a same position in each meeting place;
the step of outputting the mixed audio code streams to the meeting sections which have the corresponding relationship among the plurality of meeting places comprises:
outputting the mixed audio code streams to the meeting sections with the same position.

3. The method according to claim 2, wherein each of the audio code streams comprises position information of a meeting section, and the step of mixing the audio code streams of the meeting sections with the same position in each meeting place comprises:
mixing the audio code streams of the meeting sections with the same position in each meeting place according to the position information.

4. The method according to claim 1, wherein in a case that a first meeting place which comprises one meeting section and a second meeting place which comprises a plurality of meeting sections exist in the plurality of meeting places, the step of mixing the audio code streams of the meeting sections which have the corresponding relationship among the plurality of meeting places comprises:
mixing an audio code stream of the meeting section of the first meeting place and an audio code stream of one of the meeting sections of the second meeting place.

5. The method according to claim 4, wherein the step of outputting the mixed audio code streams to the meeting sections which have the corresponding relationship among the plurality of meeting places comprises:
outputting the mixed audio code streams to the meeting section of the first meeting place and the meeting section, of which the audio code stream is mixed with the audio code stream of the meeting section of the first meeting place, in the second meeting place.

6. The method according to claim 4, further comprising:
mixing the audio code streams of all meeting sections in the plurality of meeting places, and outputting the mixed audio code streams to the first meeting place.

7. The method according to claim 1, wherein at least one of the plurality of meeting places comprises three meeting sections, wherein the three meeting sections comprise a left meeting section, a middle meeting section and a right meeting section.

8. A multi-point sound mixing and distant view presentation apparatus, comprising:
a receiving module, configured to receive audio code streams from a plurality of meeting places, wherein each meeting place comprises one or more meeting sections, and each meeting section corresponds to one of the audio code streams;
a sound mixing module, configured to mix the audio code streams of the meeting sections which have a corresponding relationship among the plurality of meeting places; and
an outputting module, configured to output mixed audio code streams to the meeting sections which have the corresponding relationship among the plurality of meeting places.

9. A multi-point sound mixing and distant view presentation system, comprising:
a plurality of meeting places, wherein each meeting place comprises one or more meeting sections, and each meeting section corresponds to one audio code stream; and
a multi-point sound mixing and distant view presentation apparatus, configured to mix audio code streams of the meeting sections which have a corresponding relationship among the plurality of meeting places, and output mixed audio code streams to the meeting sections which have the corresponding relationship among the plurality of meeting places.

10. The system according to claim 9, wherein the meeting sections which have the corresponding relationship among the plurality of meeting places are the meeting sections with same position information in each meeting place.

11. The method according to claim 2, wherein at least one of the plurality of meeting places comprises three meeting sections, wherein the three meeting sections comprise a left meeting section, a middle meeting section and a right meeting section.

12. The method according to claim 3, wherein at least one of the plurality of meeting places comprises three meeting sections, wherein the three meeting sections comprise a left meeting section, a middle meeting section and a right meeting section.

13. The method according to claim 4, wherein at least one of the plurality of meeting places comprises three meeting sections, wherein the three meeting sections comprise a left meeting section, a middle meeting section and a right meeting section.

14. The method according to claim 5, wherein at least one of the plurality of meeting places comprises three meeting sections, wherein the three meeting sections comprise a left meeting section, a middle meeting section and a right meeting section.

15. The method according to claim 6, wherein at least one of the plurality of meeting places comprises three meeting sections, wherein the three meeting sections comprise a left meeting section, a middle meeting section and a right meeting section.
